(19) United States
(12) Patent Application Publication
(10) Pub. No.: US 2021/0312383 A1
(43) Pub. Date: Oct. 7, 2021

(54) CONTROL DEVICE, PROGRAM, AND INFORMATION PROCESSING METHOD

(71) Applicant: TOYOTA JIDOSHA KABUSHIKI KAISHA, Toyota-shi (JP)

(72) Inventor: Daiki KANEICHI, Shinagawa-ku (JP)

(73) Assignee: TOYOTA JIDOSHA KABUSHIKI KAISHA, Toyota-shi (JP)

(21) Appl. No.: 17/209,597

(22) Filed: Mar. 23, 2021

(30) Foreign Application Priority Data
Apr. 6, 2020 (JP) 2020-068552

(51) Int. Cl. G06Q 10/08; G08G 1/00; G01C 21/34; G01C 21/36

(52) U.S. Cl. CPC G06Q 10/0833; G01C 21/3605; G01C 21/3446; G08G 1/202

(57) ABSTRACT

A control device includes a controller configured to specify, based on one or more instant messages transmitted and received between a plurality of users, a facility that provides an article desired by one or more users among the users, and generate vehicle allocation information for proposing vehicle allocation of any one of a transport vehicle that transports the one or more users who desire the article to the facility as one or more target users, or a delivery vehicle that delivers the article from the facility to the one or more target users.

### CROSS-REFERENCE TO RELATED APPLICATION

This application claims priority to Japanese Patent Application No. 2020-068552 filed on Apr. 6, 2020, incorporated herein by reference in its entirety.

### BACKGROUND

### 1. Technical Field

The present disclosure relates to a control device, a program, and an information processing method.

### 2. Description of Related Art

Japanese Unexamined Patent Application Publication No. 2017-187920 (JP 2017-187920 A) discloses technology for specifying a store of an article desired by a user based on a comment input by the user to propose delivery of the article to the user.

### SUMMARY

In recent years, further improvement in the usefulness of technology for allocating a vehicle is demanded.

The present disclosure has been made in consideration of the above problem, and provides a control device, a program, and an information processing method that improve the usefulness of technology for allocating the vehicle.

A first aspect of the present disclosure relates to a control device including a controller. The controller is configured to specify, based on one or more instant messages transmitted and received between a plurality of users, a facility that provides an article desired by one or more users among the users, and generate vehicle allocation information for proposing vehicle allocation of any one of a transport vehicle that transports the one or more users who desire the article to the facility as one or more target users, and a delivery vehicle that delivers the article from the facility to the one or more target users.

A second aspect of the present disclosure relates to a program causing a computer to function as a control device including a controller. The controller is configured to specify, based on one or more instant messages transmitted and received between a plurality of users, a facility that provides an article desired by one or more users among the users, and generate vehicle allocation information for proposing vehicle allocation of any one of a transport vehicle that transports the one or more users who desire the article to the facility as one or more target users, and a delivery vehicle that delivers the article from the facility to the one or more target users.

A third aspect of the present disclosure relates to an information processing method executed by a computer. The method includes specifying, based on one or more instant messages transmitted and received between a plurality of users, a facility that provides an article desired by one or more users among the users, and generating vehicle allocation information for proposing vehicle allocation of any one of a transport vehicle that transports the one or more users who desire the article to the facility as one or more target users, and a delivery vehicle that delivers the article from the facility to the one or more target users.

With the control device, the program, and the information processing method according to the aspects of the present disclosure, the usefulness of the technology for allocating the vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an information processing system according to an embodiment;

FIG. 2 is a block diagram showing a schematic configuration of a vehicle according to the embodiment;

FIG. 3 is a block diagram showing a schematic configuration of a terminal device according to the embodiment;

FIG. 4 is a block diagram showing a schematic configuration of a control device according to the embodiment;

FIG. 5 is a diagram showing an operation example of the information processing system according to the embodiment;

FIG. 6 is a diagram showing an operation example of the information processing system according to the embodiment subsequent to FIG. 5;

FIG. 7 is a diagram showing an operation example of the information processing system according to the embodiment subsequent to FIG. 6; and

FIG. 8 is a diagram showing an example of a screen displayed on the terminal device according to the embodiment.

### DETAILED DESCRIPTION OF EMBODIMENTS

Hereinafter, an embodiment of the present disclosure will be described with reference to the drawings.

In each figure, the same or corresponding parts are designated by the same references. In the description of the embodiment, the description of the same or corresponding parts will be appropriately omitted or simplified.

Configuration of Information Processing System

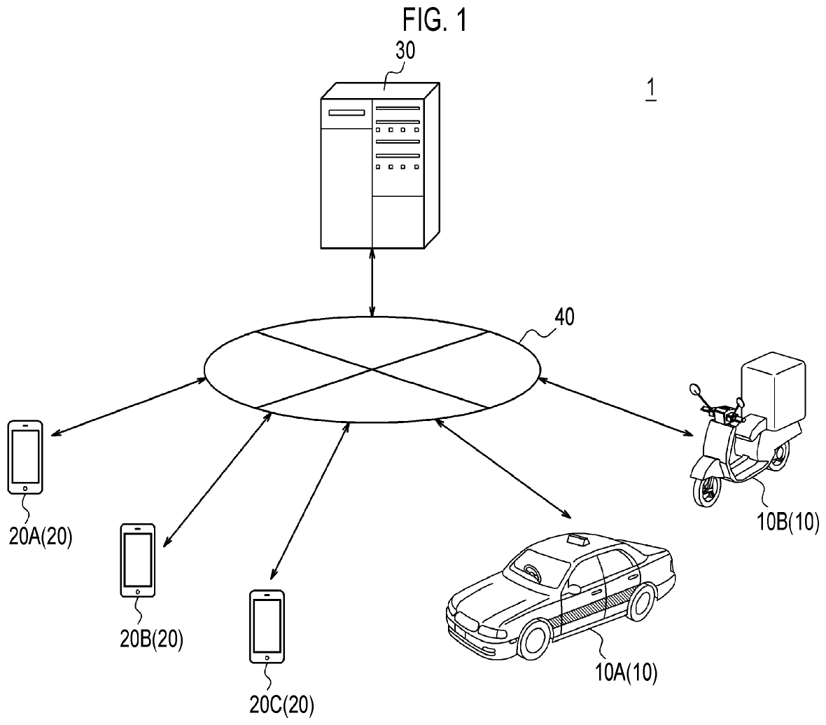

A schematic configuration of an information processing system 1 according to the embodiment will be described with reference to FIG. 1. The information processing system 1 includes a vehicle 10, a terminal device 20, and a control device 30. FIG. 1 shows two vehicles 10, three terminal devices 20, and one control device 30. However, the information processing system 1 may include any number of vehicles 10, the terminal devices 20, and the control devices 30.

The vehicle 10 is any vehicle that transports at least one of a user and an article, such as an on-demand bus, a rental car, a sharing car, a taxi, a motorcycle, a truck, or a bicycle. The vehicle 10 includes a transport vehicle 10A that transports the user, and a delivery vehicle 10B that delivers the article. In the embodiment, the description is made with assumption that the transport vehicle 10A is a taxi, and the delivery vehicle 10B is a motorcycle. However, the transport vehicle 10A and the delivery vehicle 10B may be any vehicles. The transport vehicle 10A and the delivery vehicle 10B may be the same vehicle, or may be the vehicles different from each other. Hereinafter, in a case where the transport vehicle 10A and the delivery vehicle 10B are not particularly distinguished, both vehicles will be simply collectively referred to as the vehicle 10. The vehicle 10 may be driven by a driver, or may be autonomously driven at any level. The level of autonomation is, for example, any of level 1 to level 5 in society of automotive engineers (SAE) leveling.

The terminal device 20 is, for example, a computer such as a mobile phone, a smartphone, or a personal computer. In the present specification, the computer is also referred to as an information processing device. In the embodiment, the terminal device 20 includes a terminal device 20A owned by a user U1, a terminal device 20B owned by a user U2, and a terminal device 20C owned by a user U3. Hereinafter, in a case where the terminal devices 20A, 20B, 20C are not particularly distinguished, the terminal devices will be simply collectively referred to as the terminal device 20.

The control device 30 includes one or a plurality of computers capable of communicating with each other. In the embodiment, the control device 30 provides a social networking service (SNS). In the embodiment, as an example, the description is made with assumption that the SNS is a service that provides a chat function for transmitting and receiving instant messages between a plurality of users to the user. The users are the users who participate in a user group for group chat. However, the SNS is not limited to chat, and may include a service in which the user shares information in any form such as a website or a blog.

The vehicle 10, the terminal device 20, and the control device 30 can communicate with each other via a network 40. The network 40 is any communication network in which the vehicle 10, the terminal device 20, and the control device 30 can communicate with each other. The network 40 may be a wireless or wired transmission line, or may be a communication network such as the Internet. For example, the network 40 according to the embodiment may include an ad hoc network, a metropolitan area network (MAN), a cellular network, a wireless personal area network (WPAN), a public switched telephone network (PSTN), a terrestrial wireless network, an optical network, other network, or a combination thereof.

In the information processing system 1, the control device 30 provides a chat function of transmitting and receiving instant messages between the users who participate in the user group for group chat. The control device 30 specifies the article desired by one or more users among the users based on one or more instant messages transmitted and received between the users. Hereinafter, “one or more users who desire the article” will also be referred to as “one or more target users”. The control device 30 generates information for proposing vehicle allocation of any vehicle 10 of the transport vehicle 10A that transports the one or more target users to a facility that provides the specified article, or a delivery vehicle 10B that delivers the article from the facility that provides the article to the one or more target users. Hereinafter, the “information for proposing vehicle allocation” of the vehicle 10 will also be referred to as “vehicle allocation information” of the vehicle 10. The vehicle allocation information of the vehicle 10 includes, for example, a kind of the vehicle, the number of passengers, information of departure and destination, a travel route, departure scheduled time from the departure, arrival scheduled time to the destination, a vehicle allocation method, or the cost. The control device 30 transmits the vehicle allocation information of the vehicle 10 to the terminal device 20. In the embodiment, as an example, the description is made with assumption that the facility is a restaurant, and the article provided at the facility is a food. However, the facility and the article provided at the facility may be optionally defined.

The terminal device 20 communicates with the control device 30 to display the instant messages transmitted and received in the user group in which the user of the terminal device 20 participates. The terminal device 20 further displays the vehicle allocation information of the vehicle 10 generated based on the instant messages. For example, the terminal device 20 may display the instant messages including the vehicle allocation information of the vehicle 10 in the user group in which the user of the terminal device 20 participates. As a result, the user of the terminal device 20 can refer to the vehicle allocation information of the vehicle 10 related to the instant messages while transmitting and receiving the instant messages, and thus the convenience of the technology for vehicle allocation of the vehicle 10 is improved.

Next, the vehicle 10, the terminal device 20, and the control device 30 included in the information processing system 1 will be described in detail.

Configuration of Vehicle

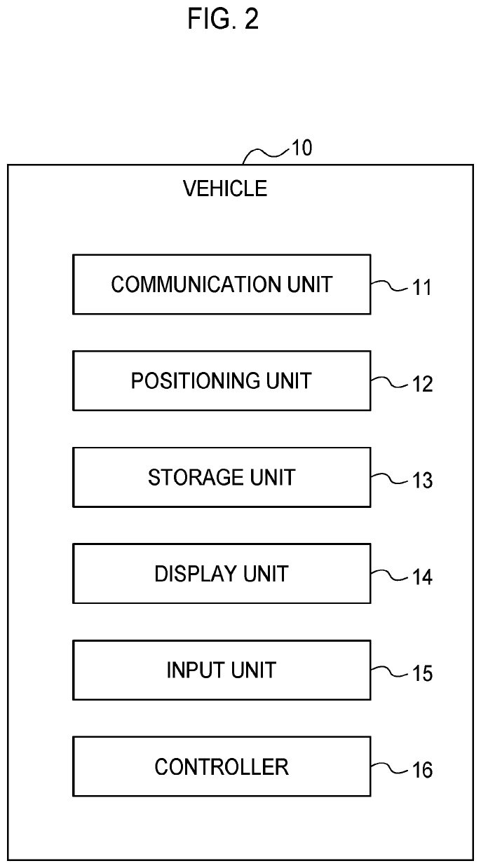

A configuration of the vehicle 10 according to the embodiment will be described with reference to FIG. 2. As shown in the block diagram of FIG. 2, the vehicle 10 includes a communication unit 11, a positioning unit 12, a storage unit 13, a display unit 14, an input unit 15, and a controller 16. The communication unit 11, the positioning unit 12, the storage unit 13, the display unit 14, the input unit 15, and the controller 16 may be built in the vehicle 10, or may be provided attachably and detachably to the vehicle 10. In a case of being provided attachably and detachably to the vehicle 10, the communication unit 11, the positioning unit 12, the storage unit 13, the display unit 14, the input unit 15, and the controller 16 may be provided in the computer attachable and detachable to the vehicle 10, such as a car navigation device. The communication unit 11, the positioning unit 12, the storage unit 13, the display unit 14, the input unit 15, and the controller 16 are connected to be able to communicate with each other by wire or wirelessly via an in-vehicle network such as a controller area network (CAN) or a dedicated line.

The communication unit 11 includes a communication module for connecting to the network 40. The communication module is a communication module supporting a mobile communication standard such as 4th generation (4G) or 5th generation (5G). The communication module may be a communication module supporting a standard such as a wired local area network (LAN) or wireless LAN. The communication module may be a communication module supporting a short-range wireless communication standard such as Wi-Fi (registered trademark), Bluetooth (registered trademark), or infrared communication. For example, an in-vehicle communication device mounted on the vehicle 10 may function as the communication unit 11. In the embodiment, the vehicle 10 is connected to the network 40 via the communication unit 11. As a result, the vehicle 10 can communicate with the control device 30.

The positioning unit 12 measures the position of the vehicle 10, and generates positional information. In the embodiment, the “positional information” is information for specifying the position. In the embodiment, the positional information includes coordinates such as two-dimensional coordinates or three-dimensional coordinates. However, the positional information is not limited to the coordinates, and may include a speed, a movement route, a movement distance, or a change amount or a change rate of the speed, the movement route, and the movement distance. The positioning unit 12 includes a receiver supporting a satellite positioning system. The satellite positioning system supported by the receiver may be, for example, a global positioning system (GPS). The positioning unit 12 may include an acceleration sensor or a gyro sensor. For example, the car navigation device mounted on the vehicle 10 may function as the positioning unit 12.

The storage unit 13 is, for example, a semiconductor memory, a magnetic memory, or an optical memory. The storage unit 13 functions as, for example, a main storage device, an auxiliary storage device, or a cache memory. The storage unit 13 stores any information used for the operation of the vehicle 10. For example, the storage unit 13 stores a system program, an application program, or an embedded software. The information stored in the storage unit 13 may be updatable with, for example, information acquired from the network 40 via the communication unit 11.

The display unit 14 displays information by an image or a text. The display unit 14 includes a display device such as a display. For example, the car navigation device may function as the display unit 14.

The input unit 15 receives an input operation. The input unit 15 includes an input device such as a touch panel, a physical key, a camera, a microphone, or an IC card reader. For example, the car navigation device may function as the input unit 15.

The controller 16 includes one or more processors. The processor may be, for example, a general-purpose processor such as a central processing unit (CPU), or a dedicated processor specialized for specific processing. The controller 16 is not limited to the processor, and may include one or more dedicated circuits. The dedicated circuit may be, for example, a field-programmable gate array (FPGA) or an application specific integrated circuit (ASIC). The controller 16 controls the components in order to realize the function of the vehicle 10 including the functions of the components of the communication unit 11, the positioning unit 12, the storage unit 13, the display unit 14, and the input unit 15.

Configuration of Terminal Device

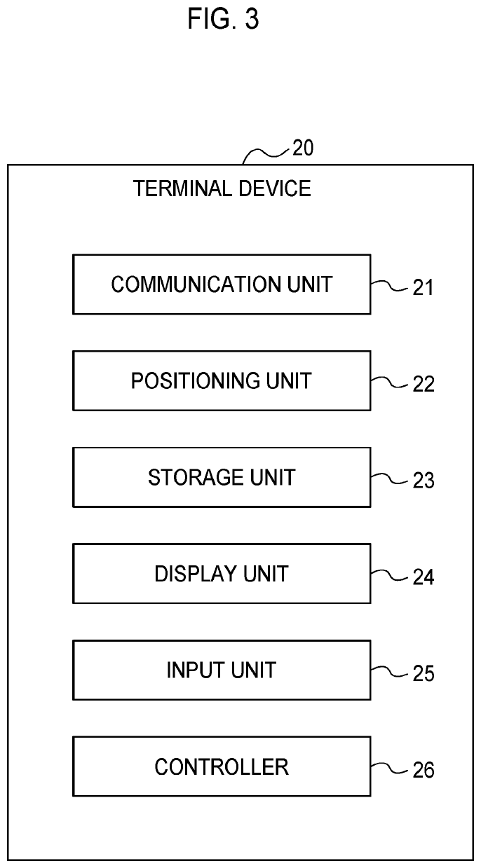

A configuration of the terminal device 20 according to the embodiment will be described with reference to FIG. 3. As shown in the block diagram of FIG. 3, the terminal device 20 includes a communication unit 21, a positioning unit 22, a storage unit 23, a display unit 24, an input unit 25, and a controller 26. The communication unit 21, the positioning unit 22, the storage unit 23, the display unit 24, the input unit 25, and the controller 26 are connected to be able to communicate with each other by wire or wirelessly.

The communication unit 21 includes a communication module for connecting to the network 40. The communication module is a communication module supporting a mobile communication standard such as 4G or 5G. The communication module may be a communication module supporting a standard such as a wired LAN or wireless LAN. The communication module may be a communication module supporting a short-range wireless communication standard such as Wi-Fi, Bluetooth, or infrared communication. In the embodiment, the terminal device 20 is connected to the network 40 via the communication unit 21. As a result, the terminal device 20 can communicate with the control device 30.

The positioning unit 22 measures the position of the terminal device 20, and generates positional information. The positioning unit 22 includes a receiver supporting a satellite positioning system. The satellite positioning system supported by the receiver may be the GPS. The positioning unit 22 may include an acceleration sensor or a gyro sensor.

The storage unit 23 is, for example, a semiconductor memory, a magnetic memory, or an optical memory. The storage unit 23 functions as, for example, a main storage device, an auxiliary storage device, or a cache memory. The storage unit 23 stores any information used for the operation of the terminal device 20. For example, the storage unit 23 stores a system program, an application program, or an embedded software. The information stored in the storage unit 23 may be updatable with, for example, information acquired from the network 40 via the communication unit 21.

The display unit 24 displays information by an image or a text. The display unit 24 includes a display device such as a display.

The input unit 25 receives an input operation. The input unit 25 includes an input device such as a touch panel, a physical key, a camera, a microphone, or an IC card reader.

The controller 26 includes one or more processors. The processor may be, for example, a general-purpose processor such as a CPU, or a dedicated processor specialized for a specific processing. The controller 26 is not limited to the processor, and may include one or more dedicated circuits. The dedicated circuit may be, for example, the FPGA or the ASIC. The controller 26 controls the components in order to realize the function of the terminal device 20 including the functions of the components of the communication unit 21, the positioning unit 22, the storage unit 23, the display unit 24, and the input unit 25.

The function of the terminal device 20 is realized by causing the processor of the computer to execute the terminal program according to the embodiment. That is, the function of the terminal device 20 is realized by software. The terminal program is a program for causing the computer to execute processing of the step included in the operation of the terminal device 20 and causing the computer to realize the function corresponding to the processing of the step. That is, the terminal program is a program for causing the computer to function as the terminal device 20.

The program can be recorded on a computer-readable non-temporary recording medium. The computer-readable non-temporary recording medium is, for example, a magnetic recording device, an optical disc, an optical magnetic recording medium, or a semiconductor memory. The distribution of the program is performed by, for example, selling, transferring, or renting a portable recording medium such as a digital versatile disc (DVD) or a compact disc read only memory (CD-ROM) in which the program is recorded. Alternatively, the program can be distributed by storing the program in the storage of a predetermined server and transferring the program from a predetermined server to another computer. The program may be provided as a program product.

The computer temporarily stores, for example, a program recorded on the portable recording medium or a program transferred from a predetermined server in the memory. The computer reads the program stored in the memory by the processor, and executes the processing in accordance with the read program by the processor. The computer may directly read the program from the portable recording medium and execute the processing in accordance with the program. The computer may execute the processing in accordance with the received program each time the program is transferred from a predetermined server to the computer. The computer may execute the processing by a so-called application service provider (ASP) type service that realizes the function solely by the execution instruction and the result acquisition without transferring the program from a predetermined server to the computer. The program includes information used for processing by the computer and compliant to the program. For example, data that is not a direct instruction to the computer, but has the property of defining the processing of the computer corresponds to “compliant to the program”.

Configuration of Control Device

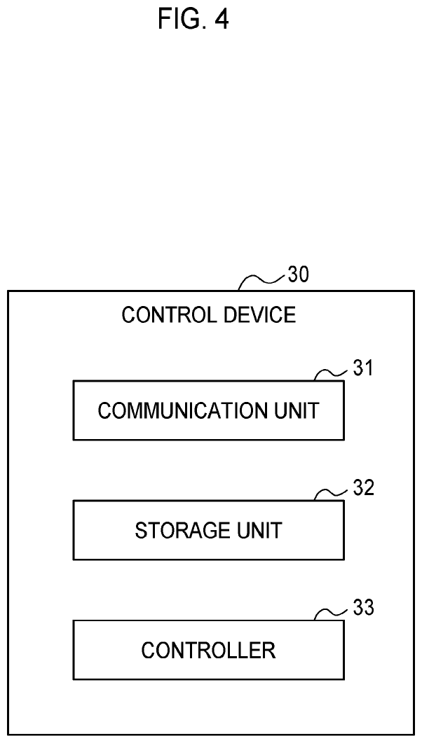

A configuration of the control device 30 according to the embodiment will be described with reference to FIG. 4. As shown in the block diagram of FIG. 4, the control device 30 includes a communication unit 31, a storage unit 32, and a controller 33. The communication unit 31, the storage unit 32, and the controller 33 are connected to be able to communicate with each other by wire or wirelessly.

The communication unit 31 includes a communication module for connecting to the network 40. The communication module is a communication module supporting a mobile communication standard such as 4G or 5G. The communication module may be a communication module supporting a standard such as a wired LAN or wireless LAN. The communication module may be a communication module supporting a short-range wireless communication standard such as Wi-Fi, Bluetooth, or infrared communication. In the embodiment, the control device 30 is connected to the network 40 via the communication unit 31. As a result, the control device 30 can communicate with the vehicle 10 and the terminal device 20.

The storage unit 32 is, for example, a semiconductor memory, a magnetic memory, or an optical memory. The storage unit 32 functions as, for example, a main storage device, an auxiliary storage device, or a cache memory. The storage unit 32 stores any information used for the operation of the control device 30. For example, the storage unit 32 stores a system program, an application program, an embedded software, or a database. The information stored in the storage unit 32 may be updatable with, for example, information acquired from the network 40 via the communication unit 31.

The controller 33 includes one or more processors. The processor may be, for example, a general-purpose processor such as a CPU, or a dedicated processor specialized for a specific processing. The controller 33 is not limited to the processor, and may include one or more dedicated circuits. The dedicated circuit may be, for example, the FPGA or the ASIC. The controller 33 controls the functions in order to realize the function of the control device 30 including the functions of the components of the communication unit 31, and the storage unit 32.

The function of the control device 30 is realized by causing the processor of the computer to execute the control program according to the embodiment. That is, the function of the control device 30 is realized by software. The control program is a program for causing the computer to execute processing of a step included in the operation of the control device 30 and causing the computer to realize the function corresponding to the processing of the step. That is, the control program is a program for causing the computer to function as the control device 30.

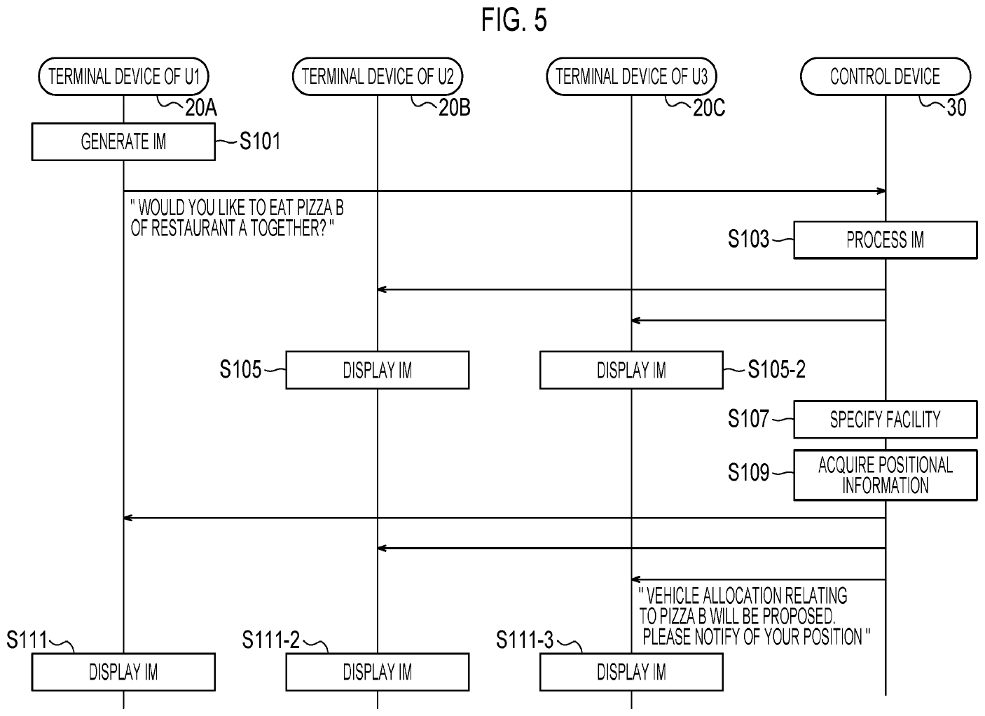

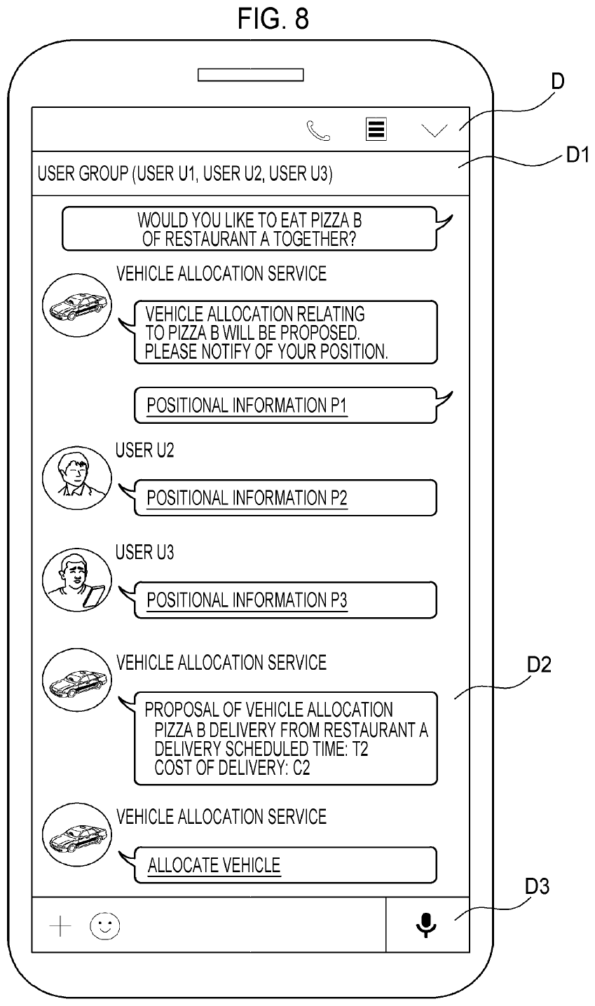

The operation of the information processing system 1 according to the embodiment will be described with reference to FIGS. 5, 6, 7, and 8. The operation corresponds to the information processing method according to the embodiment. As an example, assumption is made that the user U1, the user U2, and the user U3 participate in the user group in which the instant messages are transmitted and received between the users. The controller 33 of the control device 30 stores information for transmitting and receiving the instant message, including a login identifier (ID) and a password of each of the user U1, the user U2, and the user U3, and an internet protocol (IP) addresses of the terminal device 20A of the user U1, the terminal device 20B of the user U2, and the terminal device 20C of the user U3 in the storage unit 32 in association with the user group. As a result, the user U1, the user U2, and the user U3 can transmit and receive the instant messages between the users in the user group. FIGS. 5, 6, and 7 are diagrams showing an example of the operation of the information processing system 1. In FIGS. 5, 6, and 7, the instant message is indicated as “IM”. FIG. 8 shows an example of a screen displayed on the terminal device 20A of the user U1.

First, a flow of the processing will be described in which the control device 30 specifies the facility that provides the article desired by one or more users among the users based on one or more instant messages transmitted and received between the users.

As shown in FIG. 5, in step S101, the controller 26 of the terminal device 20A of the user U1 generates the instant message. Specifically, the controller 26 receives the operation of inputting of a text or an image transmitted by the user U1 as the instant message via the input unit 25. The controller 26 generates the instant message including the input text or image. The controller 26 transmits the generated instant message to the control device 30 via the communication unit 21. The controller 26 displays the transmitted instant message on the display unit 24.

In the example, as shown in FIG. 8, the controller 26 of the terminal device 20A displays a screen for the user U1 to input a text and an image on a touch panel display D serving as the display unit 24 and the input unit 25. The screen includes a group field D1 displaying the user group in which the users U1, U2, U3 participate, a message field D2 displaying the messages transmitted and received in the user group, and an input field D3 to which a text or an image transmitted as the instant message is input. The controller 26 receives the operation of inputting the text “Would you like to eat pizza B of the restaurant A together?” by the user U1 on the touch panel display D of the terminal device 20A. The controller 26 of the terminal device 20A transmits the instant message including the input text to the control device 30. The controller 26 of the terminal device 20A displays the text “Would you like to eat pizza B of the restaurant A together?” of the transmitted instant message on the touch panel display D.

With reference to FIG. 5, in step S103, the controller 33 of the control device 30 processes the received instant message. Specifically, the controller 33 receives the instant message transmitted in step S101 via the communication unit 31. The controller 33 stores the received instant message in the storage unit 32 as one or more instant messages transmitted and received between the users. The controller 33 transmits the received instant message to the terminal device 20B of the user U2, and the terminal device 20C of the user U3 via the communication unit 31.

In the example, the controller 33 of the control device 30 transmits the instant message including the text “Would you like to eat pizza B of the restaurant A together?” received from the terminal device 20A to the terminal device 20B and the terminal device 20C. The controller 33 stores the instant message including the text “Would you like to eat pizza B of the restaurant A together?” in the storage unit 32 as one or more instant messages transmitted and received between the users.

In step S105, the controller 26 of the terminal device 20B displays the received instant message. Specifically, the controller 26 receives the instant message transmitted in step S103 via the communication unit 21. The controller 26 displays the received instant message via the display unit 24.

In the example, the controller 26 of the terminal device 20B receives the instant message including the text “Would you like to eat pizza B of the restaurant A together?!” from the control device 30. The controller 26 displays the received instant message on the touch panel display.

In step S105-2, the controller 26 of the terminal device 20C displays the received instant message. Specifically, the controller 26 receives the instant message transmitted in step S103 via the communication unit 21. The controller 26 displays the received instant message via the display unit 24.

In the example, the controller 26 of the terminal device 20C receives the instant message including the text “Would you like to eat pizza B of the restaurant A together?!” from the control device 30. The controller 26 displays the received instant message on the touch panel display.

In step S107, the controller 33 of the control device 30 specifies the facility that provides the article desired by one or more users among the users based on one or more instant messages transmitted and received between the users.

Specifically, in a case where the text is included in one or more instant messages transmitted and received between the users, the controller 33 determines whether at least one of the text indicating the article and the text indicating the facility that provides the article is included by natural language processing. The text indicating the article may include, for example, the name, appearance feature, genre, use, or price of the article. The text indicating the facility that provides the article may include, for example, the name, appearance feature, location, occupancy building name, or employee name of the facility. In a case where determination is made that at least one of the text indicating the article and the text indicating the facility that provides the article is included in the instant message, the controller 33 specifies the facility based on the text. In the embodiment, specifying the facility includes at least specifying the position of the facility. The position of the facility is, for example, the address or coordinates of the facility. The controller 33 stores the specified facility in the storage unit 32 in association with one or more instant messages transmitted and received between the users.

In a case where the image is included in one or more instant messages transmitted and received between the users, the controller 33 determines whether at least one of the image indicating the article and the image indicating the facility that provides the article is included by image processing. The image indicating the article may include, for example, an image in which at least a part of the article is captured, or an image in which the name of the article is captured. The image indicating the facility that provides the article may include, for example, an image in which at least a part of the facility is captured, or an image in which the information specifying the name or location of the facility is captured. In a case where determination is made that at least one of the image indicating the article and the image indicating the facility that provides the article is included in the instant message, the controller 33 specifies the facility based on the image. The controller 33 stores the specified facility in the storage unit 32 as the facility that provides the article desired by one or more users.

In the example, the controller 33 of the control device 30 analyzes the text “Would you like to eat pizza B of the restaurant A together?” included in the instant message received from the terminal device 20A. The controller 33 extracts “pizza B” as the information indicating the article by natural language processing. Further, the controller 33 extracts “restaurant A” as the information indicating the facility that provides the article by natural language processing. The controller 33 performs searching on the database or the Internet based on the extracted “restaurant A” and “pizza B” and specifies the restaurant A that provides the pizza B. The controller 33 stores the specified restaurant A in the storage unit 32 as the facility that provides the article desired by one or more users.

In step S109, the controller 33 of the control device 30 generates the instant message for acquiring the positional information of the user who desires the article among the users who participate in the user group. The controller 33 transmits the generated instant message to the terminal device 20A, the terminal device 20B, and the terminal device 20C respectively via the communication unit 31.

In the example, the controller 33 of the control device 30 transmits the instant message including the text “Vehicle allocation relating to pizza B will be proposed. Please notify of your position.” to the terminal device 20A, the terminal device 20B, and the terminal device 20C.

In step S111, the controller 26 of the terminal device 20A receives the instant message transmitted in step S109 via the communication unit 21. The controller 26 displays the received instant message via the display unit 24.

In the example, the controller 26 of the terminal device 20A receives the instant message including the text “Vehicle allocation relating to pizza B will be proposed. Please notify of your position.” from the control device 30. As shown in FIG. 8, the controller 26 displays the received instant message on the touch panel display D.

With reference to FIG. 5, in step S111-2, the controller 26 of the terminal device 20B receives the instant message transmitted in step S109 via the communication unit 21. The controller 26 displays the received instant message via the display unit 24.

In the example, the controller 26 of the terminal device 20B receives the instant message including the text “Vehicle allocation relating to pizza B will be proposed. Please notify of your position.” from the control device 30. The controller 26 displays the received instant message on the touch panel display.

In step S111-3, the controller 26 of the terminal device 20C receives the instant message transmitted in step S109 via the communication unit 21. The controller 26 displays the received instant message via the display unit 24.

In the example, the controller 26 of the terminal device 20C receives the instant message including the text “Vehicle allocation relating to pizza B will be proposed. Please notify of your position.” from the control device 30. The controller 26 displays the received instant message on the touch panel display.

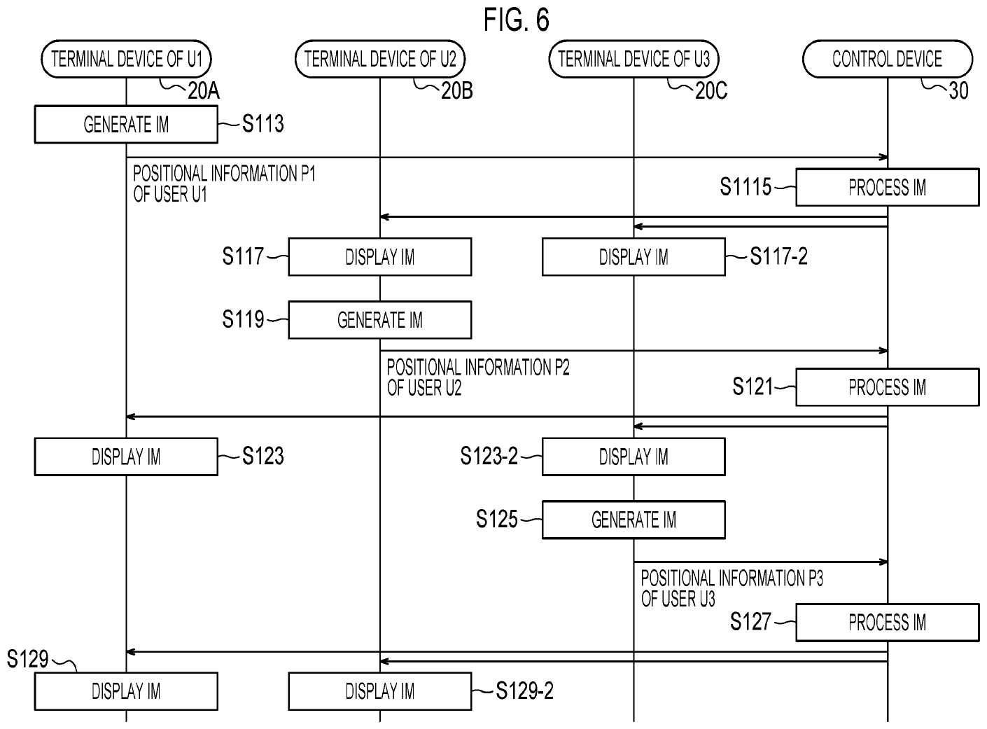

As shown in FIG. 6, in step S113, the controller 26 of the terminal device 20A generates the instant message including positional information P1 of the user U1.

In the embodiment, the controller 26 measures the position of the terminal device 20A itself by the positioning unit 22, and generates coordinates such as the two-dimensional coordinates or the three-dimensional coordinates as the positional information P1 of the user U1. As a result, the terminal device 20A can reduce the burden on the user who operates the input unit 25 to set the position. However, the controller 26 may receive the operation of inputting the text such as the address via the input unit 25, and set the input text as the positional information P1 of the user U1. The controller 26 of the terminal device 20A transmits the instant message including the generated positional information P1 of the user U1 to the control device 30 via the communication unit 21. The controller 26 of the terminal device 20A displays the transmitted instant message on the touch panel display D.

In the example, the controller 26 of the terminal device 20A generates the coordinates of the terminal device 20A itself as the positional information P1 of the user U1 using the positioning unit 22. The controller 26 transmits the instant message including the generated positional information P1 of the user U1 to the control device 30. As shown in FIG. 8, the controller 26 displays the instant message including the link of “positional information P1” on the touch panel display D. In a case where the link of “positional information P1” is clicked, the controller 26 may display the amp indicating the positional information P1 of the user U1 on the touch panel display D by activating the map application. The user of the terminal device 20A can visually grasp the positional information P1 of the user U1.

In step S115, the controller 33 of the control device 30 processes the received instant message. Specifically, the controller 33 receives the instant message transmitted in step S113 via the communication unit 31. The controller 33 stores the received instant message in the storage unit 32 as one or more instant messages transmitted and received between the users. The controller 33 transmits the received instant message to the terminal device 20B, and the terminal device 20C via the communication unit 31.

Further, the controller 33 determines whether the positional information of the user is included in the received instant message. In a case where the positional information of the user is included in the received instant message, the controller 33 determines that the user desires the article. The controller 33 stores the positional information of the user included in the received instant message as information of one or more users that desire the article in the storage unit 32.

In the example, the controller 33 of the control device 30 transmits the instant message including the positional information P1 of the user U1 received from the terminal device 20A to the terminal device 20B and the terminal device 20C. The controller 33 stores the instant message including the positional information P1 of the user U1 in the storage unit 32 as one or more instant messages transmitted and received between the users. Further, the controller 33 stores the positional information P1 of the user U1 included in the instant message in the storage unit 32 as the information of one or more users that desire the article.

In step S117, the controller 26 of the terminal device 20B displays the received instant message. Specifically, the controller 26 receives the instant message transmitted in step S115 via the communication unit 21. The controller 26 displays the received instant message via the display unit 24.

In the example, the controller 26 of the terminal device 20B receives the instant message including the positional information P1 of the user U1 from the control device 30. The controller 26 displays the instant message including the link of “positional information P1” on the touch panel display.

In step S117-2, the controller 26 of the terminal device 20C displays the received instant message. Specifically, the controller 26 receives the instant message transmitted in step S115 via the communication unit 21. The controller 26 displays the received instant message via the display unit 24.

In the example, the controller 26 of the terminal device 20C receives the instant message including the positional information P1 of the user U1 from the control device 30. The controller 26 displays the instant message including the link of “positional information P1” on the touch panel display.

In step S119, the controller 26 of the terminal device 20B generates the coordinates of the terminal device 20B itself as positional information P2 of the user U2 by using the positioning unit 22, as described for step S113. The controller 26 transmits the instant message including the generated positional information P2 of the user U2 to the control device 30 via the communication unit 21. The controller 26 displays the transmitted instant message on the touch panel display.

In step S121, the controller 33 of the control device 30 transmits the instant message including the positional information P2 of the user U2 received from the terminal device 20B to the terminal device 20A and the terminal device 20C, as described for step S115. The controller 33 stores the instant message including the positional information P2 of the user U2 in the storage unit 32 as one or more instant messages transmitted and received between the users.

Further, the controller 33 determines whether the positional information of the user is included in the instant message received from the terminal device 20B. The controller 33 stores the positional information P2 of the user U2 included in the received instant message as information of one or more users that desire the article in the storage unit 32.

In step S123, the controller 26 of the terminal device 20A receives the instant message transmitted in step S121 via the communication unit 21, as described for step S117. The controller 26 displays the received instant message via the display unit 24. Specifically, as shown in FIG. 8, the controller 26 displays the instant message including the link of “positional information P2” on the touch panel display D.

With reference to FIG. 6, in step S123-2, the controller 26 of the terminal device 20C receives the instant message transmitted in step S121 via the communication unit 21. The controller 26 displays the received instant message via the display unit 24.

In step S125, the controller 26 of the terminal device 20C transmits the generated instant message including the positional information P3 of the user U3 to the control device 30 via the communication unit 21, as described for step S113 and step S119.

In step S127, the controller 33 of the control device 30 transmits the instant message including the positional information P3 of the user U3 received from the terminal device 20C to the terminal device 20A and the terminal device 20B, as described for step S115 and step S121. The controller 33 determines whether the positional information of the user is included in the instant message received from the terminal device 20C.

In step S129, the controller 26 of the terminal device 20A receives the instant message transmitted in step S127 via the communication unit 21 and displays the received instant message via the display unit 24, as described for step S117 and step S123.

In step S129-2, the controller 26 of the terminal device 20B receives the instant message transmitted in step S127 via the communication unit 21 and displays the received instant message via the display unit 24.

In the example, the controller 33 of the control device 30 specifies the restaurant A that provides the pizza B as the facility that provides the article desired by one or more users from one or more instant messages transmitted and received between the users U1, U2, U3 by the above processing. Further, the controller 33 specifies the users U1, U2, U3 as one or more target users who desire the pizza B.

Next, a flow of processing will be described in which the control device 30 generates vehicle allocation information for proposing vehicle allocation of any one of the transport vehicle that transports the one or more target users who desire the article to the facility, and the delivery vehicle that delivers the article from the facility to the one or more target users, based on the specified facility.

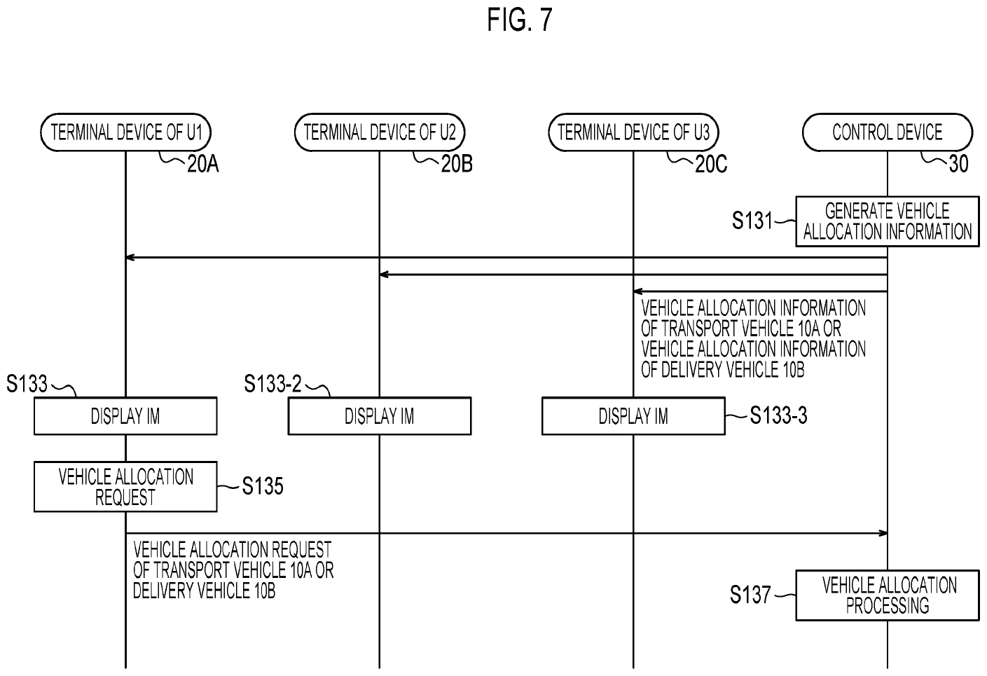

As shown in FIG. 7, in step S131, the controller 33 of the control device 30 generates the vehicle allocation information for proposing the vehicle allocation of the vehicle 10. Specifically, the controller 33 generates any one of the vehicle allocation information of the transport vehicle 10A that transports one or more target users to the facility, and the vehicle allocation information of the delivery vehicle 10B that delivers the article from the facility to one or more target users, as the vehicle allocation information of the vehicle 10. In generation of the vehicle allocation information, the controller 33 specifies the position of one or more target users based on one or more instant messages transmitted and received between the users. The controller 33 selects and generates any one of the vehicle allocation information of the transport vehicle 10A and the vehicle allocation information of the delivery vehicle 10B based on the specified position of one or more target users.

In generation of the vehicle allocation information, the controller 33 of the control device 30 determines whether a predetermined number or more of the users among one or more target users are positioned at one place. In the embodiment, a predetermined number is 2. However, a predetermined number may be any number, or may not be limited to a fixed number and be relatively decided, for example, half of one or more target users. In the embodiment, for example, the controller 33 determines that a first user and a second user are positioned at one place in a case where the distance between the first user and the second user is a predetermined value or smaller based on the positional information of the first user and the second user included in the one or more target users. However, the controller 33 may determine that the first user and the second user are positioned at one place in a case where the position of the first user and the position of the second user are mapped in the same building or site on the map by the map application.

The controller 33 of the control device 30 may generate the vehicle allocation information of the transport vehicle 10A in a case where determination is made that a predetermined number or more of the users among one or more target users are not positioned at one place. In this way, in a case where a predetermined number or more of the users are not positioned at one place, expectation is made that the users do not decide the appointed place, so proposal of transportation to the facility instead of delivery of the article is considered to be effective. The number of the transport vehicles 10A included in the vehicle allocation information of the transport vehicle 10A is one or plural depending on the position of one or more target users. The controller 33 generates, depending on the position of one or more target users, the vehicle allocation information of one transport vehicle 10A that transports the one or more target users together, or the vehicle allocation information of two or more transport vehicles 10A each of which transports at least any of one or more target users.

As an example, in a case where one or more target users are positioned on the same direction side from the facility, the controller 33 of the control device 30 can generate the vehicle allocation information of one transport vehicle 10A that transports one or more target users together. For example, the controller 33 determines that the first user and the second user are positioned on the same direction side from the facility in a case where the distance between the first user and the second user among one or more target users is shorter than the distance between the facility and the user who is farther from the facility among the first user and the second user. On the other hand, the controller 33 determines that the first user and the second user are positioned on different direction sides from the facility in a case where the distance between the first user and the second user is longer than the distance between the facility and the user who is farther from the facility among the first user and the second user.

In a case where determination is made that one or more target users are positioned on the same direction side from the facility, the controller 33 of the control device 30 generates the vehicle allocation information of the transport vehicle 10A in which the position of any one of one or more target users is the departure, the position of the other user is the transit point, and the facility is the destination. For example, the controller 33 sets the position of the user who is farthest from the facility among one or more target users as the departure. The controller 33 acquires the information of the transport vehicle 10A that can be allocated. In the embodiment, assumption is made that the controller 33 stores the information of the transport vehicle 10A that can be allocated in the storage unit 32 in advance. In a case where a plurality of the transport vehicles 10A that can be allocated is present, the controller 33 may acquire the information of the transport vehicle 10A closest to the departure. The information of the transport vehicle 10A includes, for example, the kind of the vehicle, the vehicle registration number, and the position of the transport vehicle 10A. The controller 33 generates a travel route R1 of the transport vehicle 10A based on the acquired position of the transport vehicle 10A, the departure, the transit point, and the position of the facility. The controller 33 calculates an arrival scheduled time T1 at which the transport vehicle 10A arrives at the position of the facility, a cost C1 for transporting by the transport vehicle 10A, based on the generated travel route R1 of the transport vehicle 10A. The controller 33 stores the generated travel route R1 of the transport vehicle 10A, the arrival scheduled time T1, and the cost C1 as the vehicle allocation information of the transport vehicle 10A in the storage unit 32.

As another example, in a case where one or more target users are positioned on the different direction sides from the facility, the controller 33 of the control device 30 can generate the vehicle allocation information of two or more transport vehicles 10A each of which transports at least any of one or more target users together. The controller 33 compares, for example, a first distance between the first user who is farthest from the facility among one or more target users and the facility with a second distance between the first user and the second user who is farthest from the first user. In a case where the first distance is shorter than the second distance, the controller 33 can determine that one or more target users are positioned on different direction sides from the facility.

In a case where determination is made that one or more target users are positioned on the different direction sides from the facility, the controller 33 of the control device 30 generates the vehicle allocation information of the transport vehicles 10A for each group of the users who are positioned on the same direction side from the facility among one or more target users. The controller 33 generates, for each group of the users, the vehicle allocation information of the transport vehicle 10A in which the position of any one user is the departure, the position of the other user is the transit point, and the facility is the destination. In a case where the transport vehicles 10A included in the vehicle allocation information of the transport vehicle 10A are plural, the controller 33 stores the arrival scheduled time of the transport vehicle 10A that finally arrives at the facility as the arrival scheduled time T1, and the total of the costs of the transport vehicles 10A as the cost C1 in the storage unit 32.

As still another example, the controller 33 of the control device 30 can select the vehicle allocation information of the transport vehicle 10A among candidates for the various vehicle allocation information of the transport vehicle 10A such as a case where one or more target users are transported together by one transport vehicle 10A, a case where one or more target users are distributed and transported by two transport vehicles 10A, or a case where each of one or more target users is transported individually by the transport vehicle 10A. The controller 33 stores the candidate with the earliest arrival scheduled time T1, or the candidate with the lowest cost C1 among the candidates for the vehicle allocation information of the transport vehicle 10A as the vehicle allocation information of the transport vehicle 10A in the storage unit 32.

On the other hand, the controller 33 of the control device 30 may generate the vehicle allocation information of the delivery vehicle 10B in a case where determination is made that a predetermined number or more of the users among one or more target users are positioned at one place. In this way, in a case where a predetermined number or more of the users are positioned at one place, expectation is made that the users are gathered in one place or to be gathered in one place, so proposal of delivery of the article instead of transportation to the facility is considered to be effective.

Specifically, the controller 33 of the control device 30 generates the vehicle allocation information of the delivery vehicle 10B in which the facility is the departure, and one place in which a predetermined number or more of the users are positioned is the destination. The controller 33 acquires the information of the delivery vehicle 10B that can be allocated. In the embodiment, assumption is made that the controller 33 stores the information of the delivery vehicle 10B that can be allocated in the storage unit 32 in advance. In a case where a plurality of the delivery vehicles 10B that can be allocated is present, the controller 33 may acquire the information of the delivery vehicle 10B closest to the facility. The information of the delivery vehicle 10B includes, for example, the kind of the vehicle, the vehicle registration number, and the position of the delivery vehicle 10B. The controller 33 generates a travel route R2 of the delivery vehicle 10B that delivers the article provided by the facility from the facility to one place where a predetermined number or more of the users are positioned based on the one place where a predetermined number or more of the users are positioned and the facility, and the acquired position of the delivery vehicle 10B. The controller 33 calculates a delivery scheduled time T2 at which the delivery vehicle 10B arrives at one place where a predetermined number or more of the users are positioned, and a cost C2 for delivery by the delivery vehicle 10B based on the generated travel route R2 of the delivery vehicle 10B. The controller 33 stores the generated travel route R2 of the delivery vehicle 10B, the delivery scheduled time T2, and the cost C2 as the vehicle allocation information of the delivery vehicle 10B in the storage unit 32.

In a case where determination is made that a predetermined number or more of the users are positioned at one place, the controller 33 of the control device 30 may determine whether the one place is the place where the article can be delivered.

As an example, the controller 33 of the control device 30 may store the delivery destination in association with each user in the storage unit 32, and determine whether the one place where a predetermined number or more of the users are positioned is the place that is associated with at least any of the users as the delivery destination. As the delivery destination, for example, the place such as the home or the workplace of the user may be defined by coordinates or the address. The controller 33 may generate the vehicle allocation information of the delivery vehicle 10B to one place in a case where determination is made that one place where a predetermined number or more of the users are positioned is a place associated with at least any of the users as the delivery destination. On the other hand, the controller 33 may generate the vehicle allocation information of the transport vehicle 10A in a case where determination is made that one place where a predetermined number or more of the users are positioned is not a place associated with at least any of the users as a delivery destination.

As another example, the controller 33 of the control device 30 may store the information indicating the place where the article can be delivered in the storage unit 32, and determine whether one place where a predetermined number or more of the users are positioned is the place where the article can be delivered based on the information. In the information indicating the place where the article can be delivered, the place where the article can be delivered, such as a campsite, may be defined by coordinates or the address. Alternatively, in the information indicating the place where the article can be delivered, the place where the article cannot be delivered, such as a restaurant, may be defined by coordinates or the address. In a case where determination is made that one place where a predetermined number or more of the users are positioned is the place where the article can be delivered based on the information indicating the place where the article can be delivered, the controller 33 of the control device 30 may generate the vehicle allocation information of the delivery vehicle 10B to one place. On the other hand, in a case where determination is made that one place where a predetermined number or more of the users are positioned is not the place where the article can be delivered, the controller 33 may generate the vehicle allocation information of the transport vehicle 10A.

The controller 33 of the control device 30 generates the instant message including the generated vehicle allocation information of any one of the transport vehicle 10A and the delivery vehicle 10B. The controller 33 transmits the generated instant message to the terminal device 20A, the terminal device 20B, and the terminal device 20C respectively via the communication unit 31.

In the example, assumption is made that the users U1, U2 among the users U1, U2, U3 are positioned at one place. The controller 33 of the control device 30 determines that the user U1 and the user U2 are positioned at one place based on the positional information P1 of the user U1, the positional information P2 of the user U2, and the positional information P3 of the user U3. The controller 33 determines that two or more users are positioned at one place, and generates the travel route R2 of the delivery vehicle 10B that delivers the article provided by the facility from the facility to one place where the user U1 and the user U2 are positioned. On the other hand, the controller 33 expects that the user U3 is also to be come to one place based on one or more instant messages, and does not propose the individual vehicle allocation with respect to the user U3. The controller 33 calculates a delivery scheduled time T2 of the delivery vehicle 10B, and a cost C2 for delivery by the delivery vehicle 10B based on the generated travel route R2 of the delivery vehicle 10B. The controller 33 generates the instant message including the delivery scheduled time T2 and the cost C2 of the delivery vehicle 10B as the vehicle allocation information and transmits the generated instant message to the terminal device 20A, the terminal device 20B, and the terminal device 20C.

In step S133, the controller 26 of the terminal device 20A receives the instant message transmitted in step S131 via the communication unit 21. The controller 26 displays the received instant message via the display unit 24.

In the example, the controller 26 of the terminal device 20A receives the instant message including the delivery scheduled time T2 and the cost C2 of the delivery vehicle 10B from the control device 30. As shown in FIG. 8, the controller 26 displays the received instant message on the touch panel display D.

With reference to FIG. 7, in step S133-2, the controller 26 of the terminal device 20B receives the instant message transmitted in step S131 via the communication unit 21. The controller 26 displays the received instant message via the display unit 24.

In the example, the controller 26 of the terminal device 20B receives the instant message including the delivery scheduled time T2 and the cost C2 of the delivery vehicle 10B from the control device 30. The controller 26 displays the received instant message on the touch panel display.

In step S133-3, the controller 26 of the terminal device 20C receives the instant message transmitted in step S131 via the communication unit 21. The controller 26 displays the received instant message via the display unit 24.

In the example, the controller 26 of the terminal device 20C receives the instant message including the delivery scheduled time T2 and the cost C2 of the delivery vehicle 10B from the control device 30. The controller 26 displays the received instant message on the touch panel display.

In step S135, the controller 26 of the terminal device 20A generates a vehicle allocation request of the transport vehicle 10A or the delivery vehicle 10B. The vehicle allocation request may include, for example, the information for designating the vehicle allocation information of the transport vehicle 10A for requesting the vehicle allocation of the transport vehicle 10A. The vehicle allocation request may include, for example, the information for designating the vehicle allocation information of the delivery vehicle 10B for requesting the vehicle allocation of the delivery vehicle 10B. The controller 26 of the terminal device 20A transmits the generated vehicle allocation request to the control device 30 via the communication unit 21. In the embodiment, as an example, the description will be made with assumption in which the processing of the step is executed in the terminal device 20A. However, the processing of the step may be executed in other terminal devices 20B, 20C that receive the instant message including the vehicle allocation information of the transport vehicle 10A or the delivery vehicle 10B from the control device 30.

In the example, as shown in FIG. 8, the controller 26 of the terminal device 20A displays the instant message including the link of “vehicle allocation of delivery vehicle” together with the instant message including the vehicle allocation information of the delivery vehicle 10B on the touch panel display. In a case where the link of “vehicle allocation of delivery vehicle” is clicked by the user 111, the controller 26 generates the vehicle allocation request of the delivery vehicle 10B. Alternatively, in a case where the operation of inputting a specific text or image indicating the vehicle allocation request by the user U1 is received, the controller 26 may generate the vehicle allocation request of the delivery vehicle 10B. The controller 26 transmits the generated vehicle allocation request of the delivery vehicle 10B to the control device 30.

In step S137, the controller 33 of the control device 30 registers the received vehicle allocation request of the transport vehicle 10A or the delivery vehicle 10B. Specifically, the controller 33 receives the vehicle allocation request transmitted in step S135 via the communication unit 31. The controller 33 stores the received vehicle allocation request in the storage unit 32. In a case where the received vehicle allocation request is the vehicle allocation request of the transport vehicle 10A, the controller 33 may execute processing of vehicle allocation of the transport vehicle 10A. In a case where the received vehicle allocation request is the vehicle allocation request of the delivery vehicle 10B, the controller 33 may execute processing of vehicle allocation of the delivery vehicle 10B. Further, after the vehicle allocation processing of the transport vehicle 10A or the delivery vehicle 10B is completed, the controller 33 may execute processing of requesting the cost of the vehicle allocation by electronic payment with respect to the user of the terminal device 20 that transmits the vehicle allocation request.

In the example, the controller 33 of the control device 30 receives the vehicle allocation request of the delivery vehicle 10B from the terminal device 20A, and executes the processing of vehicle allocation of the delivery vehicle 10B. After the vehicle allocation of the delivery vehicle 10B is completed, the controller 33 executes the processing of requesting the cost of the vehicle allocation with respect to the user U1 of the terminal device 20A.

As described above, the control device 30 according to the embodiment includes the controller 33 that specifies, based on one or more instant messages transmitted and received between the users, the facility that provides the article desired by one or more users among the users, and generates the vehicle allocation information for proposing the vehicle allocation of any one of the transport vehicle 10A that transports one or more users who desire the article to the facility as one or more target users, and the delivery vehicle 10B that delivers the article from the facility to the one or more target users. According to such a configuration, the control device 30 can propose the vehicle allocation of the transport vehicle 10A or the delivery vehicle 10B related to the article desired by the user to the user based on one or more instant messages transmitted and received between the users. Therefore, the control device 30 can improve the usefulness of technology for vehicle allocation of the vehicle 10.

In the control device 30 according to the embodiment, the controller 33 may be configured to specify, based on one or more instant messages, a position of the one or more target users, and select and generate, based on the position of one or more target users, the vehicle allocation information of any one of the transport vehicle 10A and the delivery vehicle 10B. According to such a configuration, the control device 30 can propose the vehicle allocation by selecting the transport vehicle 10A or the delivery vehicle 10B depending on the position of the user, and can improve the satisfaction of the user.

In the control device 30 according to the embodiment, the controller 33 may be configured to, in a case where determination is made that a predetermined number or more of the users among one or more target users are not positioned at one place, generate the vehicle allocation information of the transport vehicle 10A According to such a configuration, in a case where expectation is made that the users do not decide the appointed place, the control device 30 can propose transportation to the facility instead of delivery of the article.

In the control device 30 according to the embodiment, the controller 33 may be configured to generate, depending on the position of one or more target users, the vehicle allocation information of one transport vehicle 10A that transports one or more target users together, or the vehicle allocation information of two or more transport vehicles 10A each of which transports at least any of one or more target users. According to such a configuration, the control device 30 can propose the vehicle allocation by changing the number of transport vehicles depending on the position of the user, and can improve the satisfaction of the user.

In the controller 33 according to the embodiment, the control device 30 may be configured to, in a case where determination is made that a predetermined number or more of the users among one or more target users are positioned at one place, generate the vehicle allocation information of the delivery vehicle 10B. According to such a configuration, in a case where expectation is made that the users are gathered in one place or to be gathered in one place, the control device 30 can propose delivery of the article instead of transportation to the facility.

In the control device 30 according to the embodiment, the controller 33 may be configured to, in a case where determination is made that the one place is a place associated with at least any of the users as a delivery destination, generate the vehicle allocation information of the delivery vehicle 10B to one place. According to such a configuration, the control device 30 can propose the delivery of the article in a case where the user is positioned at the place where the article can be delivered, and can improve the satisfaction of the user.

In the control device 30 according to the embodiment, the controller 33 may be configured to, in a case where determination is made that one place is a place where the article is able to be delivered based on information indicating the place where the article is able to be delivered, generate the vehicle allocation information of the delivery vehicle 10B to the one place. According to such a configuration, the control device 30 can reduce the probability that trouble occurs due to the proposed delivery of article.

In the control device 30 according to the embodiment, the controller 33 may execute control of transmitting of the instant message including the vehicle allocation information. According to such a configuration, the control device 30 can provide the vehicle allocation information of the vehicle 10 related to the instant message to the terminal device 20 together with the instant message transmitted and received by the user.

Although the present disclosure has been described based on the drawings and examples, it should be noted that those skilled in the art can make various modifications and corrections based on the present disclosure. Therefore, it should be noted that these modifications and corrections are included in the scope of the present disclosure. For example, the functions included in each means or each step can be rearranged so as not to be logically inconsistent, and a plurality of means or steps can be combined into one or divided.

For example, in the embodiment, the control device 30 may be configured such that the control device 30 executes a part or all of the operations and processing executed by the terminal device 20. Alternatively, the terminal device 20 may be configured such that the terminal device 20 executes a part or all of the operations and processing executed by the control device 30.

Alternatively, in the embodiment, in a case where determination is made that the instant message is transmitted from a predetermined number or more of other users (for example, a majority) for the instant message including the text or the image indicating the article or the facility that provides the article posted by any user of the users who participate in the chat, the controller 33 of the control device 30 may transmit the instant message including the vehicle allocation information related to the instant message. According to such a configuration, the control device 30 can propose delivery of the article in which the users who participate in the chat have an interest, or transportation to the facility that provides the article.

Further, in the embodiment, the controller 33 of the control device 30 may transmit the instant message including the vehicle allocation information with respect to solely the user who transmits the instant message desired for the article among the users who participate in the chat. Alternatively, the controller 33 may transmit the instant message including the vehicle allocation information with respect to solely the user who completes registration of reception of the vehicle allocation information in advance.

Further, in the embodiment, the description is made with assumption in which after the vehicle allocation processing of the vehicle 10 is completed, the controller 33 of the control device 30 executes the processing of requesting the cost of the vehicle allocation by electronic payment with respect to the user U1 in accordance with the vehicle allocation request of the vehicle 10 by the user U1. However, the controller 33 of the control device 30 may decide whether to request the cost of the vehicle allocation with respect to any user of the users and execute requesting processing with respect to the decided user. For example, the controller 33 of the control device 30 may execute requesting processing with respect to all of the users who transmit the instant message desired for the article among the users who participate in the chat by evenly dividing the costs of the vehicle allocation.

What is claimed is:

1. A control device comprising a controller configured to
specify, based on one or more instant messages transmitted and received between a plurality of users, a facility that provides an article desired by one or more users among the users, and
generate vehicle allocation information for proposing vehicle allocation of any one of a transport vehicle that transports the one or more users who desire the article to the facility as one or more target users, and a delivery vehicle that delivers the article from the facility to the one or more target users.

2. The control device according to claim 1, wherein the controller is configured to specify, based on the one or more instant messages, a position of the one or more target users, and select and generate, based on the position of the one or more target users, the vehicle allocation information of any one of the transport vehicle and the delivery vehicle.

3. The control device according to claim 2, wherein the controller is configured to, in a case where determination is made that a predetermined number or more of the users among the one or more target users are not positioned at one place, generate the vehicle allocation information of the transport vehicle.

4. The control device according to claim 3, wherein the controller is configured to generate, depending on the position of the one or more target users, the vehicle allocation information of one transport vehicle that transports the one or more target users together, or the vehicle allocation information of two or more transport vehicles each of which transports at least any of the one or more target users.

5. The control device according to claim 2, wherein the controller is configured to, in a case where determination is made that a predetermined number or more of the users among the one or more target users are positioned at one place, generate the vehicle allocation information of the delivery vehicle.

6. The control device according to claim 5, wherein the controller is configured to, in a case where determination is made that the one place is a place associated with at least any of the users as a delivery destination, generate the vehicle allocation information of the delivery vehicle to the one place.

7. The control device according to claim 5, wherein the controller is configured to, in a case where determination is made that the one place is a place where the article is able to be delivered based on information indicating the place where the article is able to be delivered, generate the vehicle allocation information of the delivery vehicle to the one place.

8. The control device according to claim 1, further comprising a communication unit configured to communicates with a terminal device of the user,
wherein the controller is configured to transmit the instant messages including the vehicle allocation information to the terminal device via the communication unit.

9. A program causing a computer to function as a control device including a controller configured to
specify, based on one or more instant messages transmitted and received between a plurality of users, a facility that provides an article desired by one or more users among the users, and
generate vehicle allocation information for proposing vehicle allocation of any one of a transport vehicle that transports the one or more users who desire the article to the facility as one or more target users, and a delivery vehicle that delivers the article from the facility to the one or more target users.

10. The program according to claim 9, wherein the controller is configured to specify, based on the one or more instant messages, a position of the one or more target users, and select and generate, based on the position of the one or more target users, the vehicle allocation information of any one of the transport vehicle and the delivery vehicle.

11. The program according to claim 10, wherein the controller is configured to, in a case where determination is made that a predetermined number or more of the users among the one or more target users are not positioned at one place, generate the vehicle allocation information of the transport vehicle.

12. The program according to claim 11, wherein the controller is configured to generate, depending on the position of the one or more target users, the vehicle allocation information of one transport vehicle that transports the one or more target users together, or the vehicle allocation information of two or more transport vehicles each of which transports at least any of the one or more target users.

13. The program according to claim 10, wherein the controller is configured to, in a case where determination is made that a predetermined number or more of the users among the one or more target users are positioned at one place, generate the vehicle allocation information of the delivery vehicle.

14. The program according to claim 13, wherein the controller is configured to, in a case where determination is made that the one place is a place associated with at least any of the users as a delivery destination, generate the vehicle allocation information of the delivery vehicle to the one place.

15. An information processing method executed by a computer, the information processing method comprising:
specifying, based on one or more instant messages transmitted and received between a plurality of users, a facility that provides an article desired by one or more users among the users; and
generating vehicle allocation information for proposing vehicle allocation of any one of a transport vehicle that transports the one or more users who desire the article to the facility as one or more target users, and a delivery vehicle that delivers the article from the facility to the one or more target users.

16. The information processing method according to claim 15, wherein the generating of the vehicle allocation information includes specifying, based on the one or more instant messages, a position of the one or more target users, and selecting and generating, based on the position of the one or more target users, the vehicle allocation information of any one of the transport vehicle and the delivery vehicle.

17. The information processing method according to claim 16, wherein the generating of the vehicle allocation information includes generating the vehicle allocation information of the transport vehicle in a case where determination is made that a predetermined number or more of the users among the one or more target users are not positioned at one place.

18. The information processing method according to claim 17, wherein the generating of the vehicle allocation information includes generating, depending on the position of the one or more target users, the vehicle allocation information of one transport vehicle that transports the one or more target users together, or the vehicle allocation information of two or more transport vehicles each of which transports at least any of the one or more target users.

19. The information processing method according to claim 16, wherein the generating of the vehicle allocation information includes generating the vehicle allocation information of the delivery vehicle in a case where determination is made that a predetermined number or more of the users among the one or more target users are positioned at one place.

20. The information processing method according to claim 19, wherein the generating of the vehicle allocation information includes generating the vehicle allocation information of the delivery vehicle to the one place in a case where determination is made that the one place is a place associated with at least any of the users as a delivery destination.
